(19) United States
(12) Patent Application Publication
(10) Pub. No.: US 2010/0196257 A1
(43) Pub. Date: Aug. 5, 2010

(54) METAL COORDINATION COMPOUND AND PRODUCTION PROCESS THEREOF

(75) Inventor: Tetsushi Yamamoto, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/526,198

(22) PCT Filed: Feb. 28, 2008
(86) PCT No.: PCT/JP2008/054002

§ 371 Date: Aug. 6, 2009

(30) Foreign Application Priority Data
Mar. 1, 2007 (JP) 2007-051574

(51) Int. Cl. C01G 23/047; C01B 13/00

(52) U.S. Cl. 423/611; 423/579; 204/157.43

(57) ABSTRACT

In order to provide nanoscale metal oxide fine particles having an excellent dispersibility in an organic solvent, metal oxide fine particles are obtained by heating and reacting metal halide and metal alkoxide in the presence of phosphine oxide. The heating is performed by microwave irradiation.

### TECHNICAL FIELD

The present invention related to metal oxide fine particles and a production process thereof and is suitably applicable to a coloring material, a catalyst, an optical material, photonic crystal, a dielectric material, an electrode, electronic and semiconductor materials, a solar cell, and the like.

### BACKGROUND ART

In recent years, nanoscale metal oxide fine particles are employed in various uses. For example, organic and inorganic nano-composite materials containing a polymeric resin material and titanium oxide fine particles of 100 nm or less mixed in the polymeric resin material allow visible light to pass therethrough but absorb ultraviolet rays, so that these materials are utilized for plastics packaging materials in foods or pharmaceuticals, plastics coating materials in farms or horticulture, cosmetics, and the like. However, the titanium oxide fine particles of 100 nm or less have very high surface energy, so that they easily agglomerate. Therefore, when the fine particles are mixed in the polymeric resin material, the agglomerated fine particles are present in the polymer resin material. For this reason, the titanium oxide fine particles fail to sufficiently exhibit their original visible light transmissibility and ultraviolet absorbance.

In order to enhance dispersibility of the nanoparticles, many methods for suppressing agglomeration by coating-treating surfaces of metal oxide fine particles with a modifier have been conventionally proposed. In these cases, before performing the coating treatment on the particles, it is necessary to disperse powder of the metal oxide fine particles into a primary particle state. However, it is difficult to disperse the agglomerated metal oxide fine particles during production into the primary particle state again. As a result, it is difficult to industrially stably produce the metal oxide fine particles excellent in dispersibility.

In view of this problem, an attempt to highly disperse metal oxide fine particles of primary particles by coating particle surfaces before the produced metal oxide fine particles of primary particles are agglomerated has been proposed. This is a method in which production of the metal oxide fine particles and surface treatment with a modifier are performed simultaneously.

As an example thereof, it is possible to use nonhydrolysis reaction. It is, known that this nonhydrolysis reaction is endothermic reaction, which is a method wherein metal oxide fine particles surface-modified with trioctylphosphine oxide (TOPO) acting as a surface modifier are obtained in situ by reacting metal halide with metal alkoxide in the presence of the TOPO.

For example, in the case of titanium oxide, titanium halide such as titanium tetrachloride and titanium alkoxide such as titanium tetraisopropoxide and reacted through the following formulas (1) and (2) (T. J. Trentler et al., J. Am. Chem. Soc., 121, 1613 (1999) (“nonpatent document 1”):

TiX₄+Ti(OR)₄→TiO₂+4RX (1),

wherein X is any of fluorine, chlorine, bromine and iodine, and R is an alkyl group such as methyl, ethyl, propyl, iso-propyl, n-butyl or t-butyl; and

TiCl₄+Ti(OiPr)₄→TiO₂

Further, it is also possible to form metal oxide fine particles other than titanium oxide fine particles and composite metal oxide fine particles containing a plurality of metals by changing or combining species of the metal halide and/or the metal alkoxide (S. Chang et al., J. Phys. Chem. B, 110, 20808/2006) (“nonpatent document 2”) and J. Tang et al., Chem. Mater., 16, 1336 (2004) (“nonpatent document 3”)).

Incidentally, in recent years, a method in which heating with microwave irradiation is utilized for synthesizing metal oxide nanoparticles has been proposed. For example, a process for producing anatase titanium oxide nanocrystal through hydrolysis and crystallization by adding water into a solvent of polyol (e.g., alkanediol) containing hydrolyzable metal alkoxide (e.g., titanium tetraisopropoxide (Ti(OiPr)₄) and irradiating the solvent with microwave has been disclosed (Japanese Laid-Open Patent Application No. 2003-342007).

However, in either of the above-described conventional methods, surface modification with respect to the particles is not sufficient, so that resultant metal oxide fine particles are agglomerated secondary particles in many cases. That is, desired dispersibility in an organic solvent is not obtained.

### DISCLOSURE OF THE INVENTION

A principal object of the present invention is to provide nanoscale metal oxide fine particles exhibiting nonconventional excellent dispersibility in an organic solvent and a production process of the metal oxide fine particles.

According to an aspect of the present invention, there is provided metal oxide fine particles obtained by heating metal halide and metal alkoxide in the presence of phosphine oxide,

wherein the heating is performed by microwave irradiation.

According to another aspect of the present invention, there is provided a process for producing metal oxide fine particles, comprising:

heating metal halide and metal alkoxide in the presence of phosphine oxide through microwave irradiation.

The metal oxide fine particles according to the present invention exhibit the nonconventional excellent dispersibility in the organic solvent as primary particles although the metal oxide fine particles are nanoscale fine particles liable to cause agglomeration. Further, according to the production process of the metal oxide fine particles of the present invention, it is possible to obtain the metal oxide fine particles exhibiting high dispersibility in the organic solvent in a short time.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic view showing an experimental system in Example of the present invention.

FIG. 2 is an X-ray diffraction (XRD) spectrum of titanium oxide fine particles obtained in Example of the present invention and Comparative Example.

FIGS. 3(a) and 3(b) are photographic images observed through a transmission electron microscope with respect to titanium oxide fine particles obtained in Example of the present invention and Comparative Example, respectively.

FIG. 4 is an infrared absorption spectrum of titanium oxide fine particles obtained in Example of the present invention and Comparative Example.

FIG. 5 is a thermogravimetric analysis (TGA) graph of titanium oxide fine particles obtained in Example of the present invention and Comparative Example.

### BEST MODE FOR CARRYING OT THE INVENTION

Preferred embodiments of the present invention will be described in detail with reference to the drawings.

Production of metal oxide fine particles through nonhydrolysis reaction is performed by a process in which metal halide and metal alkoxide are heated and reacted in the presence of phosphine oxide. Metal species of the metal halide may include titanium, zirconium, hafnium, silicon, zinc, tin, indium, etc. Examples of the halide may include fluoride, chloride, bromide, iodide, etc. Typical examples of the metal halide may include titanium tetrachloride, zirconium tetrachloride, hafnium tetrachloride, etc. Metal species of the metal alkoxide may include titanium, zirconium, hafnium, silicon, zinc, tin, indium, etc. Examples of the alkoxide may include methoxide, ethoxide, propoxide, isopropoxide, n-butoxide, t-butoxide, etc. By combining the metal halide and metal alkoxide of various metal species, it is possible to produce various types of metal oxide fine particles as described in the nonpatent documents 1 to 3. For example, it is possible to produce fine particles of metal oxides of a single metal species such as titanium oxide, zirconium oxide, and hafnium oxide and fine particles of composite metal oxides of plural metal species such as ZrₓHf₍₁₋ₓ₎O₂, TiₓZr_{(1-x)O}₂, SiZrO₄, and SiTiO₄ through, e.g., the following reaction formulas (3) to (5):

ZrCl₄+Zr(OiPr)₄→ZrO₂ (3)

xZrCl₄+(1-x)Hf(OiPr)₄→ZrₓHf₍₁₋ₓ₎O₂ (4)

xTiCl₄+(1-x)Zr(OiPr)₄→TiₓZr₍₁₋ₓ₎O₂ (5)

In the right-hand sides of the above formulas (3) to (5), only the metal oxides are shown.

With respect to TiO₂, it is possible to effect doping. As an element capable of doping, it is possible to use Cr, Fe, V, Nb, Sb, Sn, P, Si, Al, S, N, Eu, Nb, etc.

The above-described nonhydrolysis reaction is endothermic reaction, so that it is necessary to heat the reaction system in the presence of phosphine oxide. The metal oxide fine particles of the present invention are characterized in that the heating is performed by microwave irradiation. As a result, it is possible to produce metal oxide fine particles having high dispersibility with respect to an organic solvent in a short time.

Conventional metal oxide fine particles were not fine particles exhibiting high dispersibility in the organic solvent in a primary particle state. Specifically, only a part of the fine particles is dispersed into the organic solvent but most of the fine particles is settled in the organic solvent or dispersed into the organic solvent in an agglomerated secondary particle state, thus resulting in a suspension in many cases. The suspension is not transparent to visible light and is colored various colors depending on types of a solvent or an additive.

On the other hand, the metal oxide fine particles of the present invention exhibit high dispersibility into the organic solvent in the primary particle state, so that the metal oxide fine particles are transparent to visible light and cause no partial setting.

The reason why the above-described metal oxide fine particles are obtained by performing heating through microwave irradiation will be described below by taking titanium oxide (TiO₂) fine particles as an example.

In the nonhydrolysis reaction for producing the titanium oxide fine particles represented by the above-described formula (1), the surfaces of the titanium oxide fine particles are modified with phosphine oxide during production of the titanium oxide fine particles by endothermic reaction. This is because TI⁴⁺ (δ+) of the surfaces of the titanium oxide fine particles and P=O group (δ−) cause electrostatic coordinate bonding.

It is known that the P=O group of phosphine oxide is polarized and thus efficiently absorbs microwave, thus resulting in a high heat generation efficiency. The coordinate bond is also polarized, so that it is considered that the coordinate bond selectively absorbs the microwave used for irradiation to generate heat. Accordingly, even in the nonhydrolysis reaction which is the endothermic reaction, it is possible to sufficiently supply heat to a coordinate bond state. As a result, in situ surface modification of the titanium oxide fine particles with phosphine oxide through the coordinate bond occurs efficiently, so that it is possible to effect sufficient crystallization in a short time. The coordinate bond between the surfaces of the titanium oxide fine particles and the phosphine oxide is increased and thus the surfaces of the titanium oxide fine particles are sufficiently hydrophobized, so that mutual agglomeration among nanoparticles is suppressed and as a result, dispersibility of primary nanoparticles into the organic solvent is improved.

On the other hand, in the case of the conventional heating as described in the above-mentioned nonpatent document 1, energy is provided by heat conduction, so that the nonhydrolysis reaction itself which is the endothermic reaction cannot be expected to be an efficient reaction. Further, heat is not sufficiently conducted to the coordinate bond site, so that formation of the coordinate bond is insufficient. As a result, the in situ surface modification with the phosphine oxide is not efficiently performed, so that sufficient dispersibility of the primary nanoparticles into the organic solvent is not obtained.

As described in the above-mentioned nonpatent documents 2 and 3, the nonhydrolysis reaction described above is applicable to not only production of the titanium oxide fine particles but also other metal oxide fine particles or so-called composite metal oxide fine particles of a plurality of metal species. Also in these cases, a similar mechanism such that coordinate bond is formed between the phosphine oxide and the metal positively charged in situ at the particle surfaces during production of the metal oxide fine particles can be considered. Accordingly, the metal oxide fine particles with high dispersibility produced by the microwave irradiation in the present invention is not limited to the titanium oxide fine particles but may include metal oxide fine particles in general capable of being produced by the nonhydrolysis reaction.

In order to suppress the agglomeration of the primary particles of the metal oxide fine particles, the phosphine oxide for the surface modification may preferably be trialkylphosphine oxide containing an alkyl group having 4-20 carbon atoms. In view of the above-described mechanism, it is important that the phosphine oxide has the P=O group, so that the kind of the phosphine oxide is not limited. However, in the case where the carbon number is less than four, repulsion due to steric hindrance is small and therefore nanoparticles formed are liable to agglomerate, so that the metal oxide fine particles with high dispersibility cannot be produced. On the other hand, in the case where the carbon number is more than 20, a longer chain length inhibits crystal growth, so that it is difficult to produce nanoparticles having a desired particle size.

The metal oxide fine particles of the present invention may preferably have a particle size of 100 nm or less in order to exhibit excellent visible light transmissivity. Further, the metal oxide fine particles produced through the microwave heating nonhydrolysis reaction process may preferably have a particle size of 1-100 nm. Herein, the particle size means a crystalline diameter of the primary particles.

Further, in the present invention, the metal oxide fine particles may preferably have an average particle size of 1 nm or more and 50 nm or less from the viewpoint of visible light transmissivity. Herein, the average particle size means a value calculated by using Debye-Scherrer formula described later in Example.

The microwave used in the present invention means electromagnetic wave having a frequency of 300 MHz to 300 GHz. For industrial purpose, a frequency of 2.45 GHz may preferably be used but it is also possible to use those having ISM (industrial scientific and medical) frequency band.

An irradiation density of the microwave is energy required that the temperature of the reaction system reaches a nonhydrolysis reaction temperature and may preferably be 0.1-50 W/cm³. Below 0.1 W/cm³, it is difficult to heat the reaction system up to the reaction temperature.

### EMBODIMENT

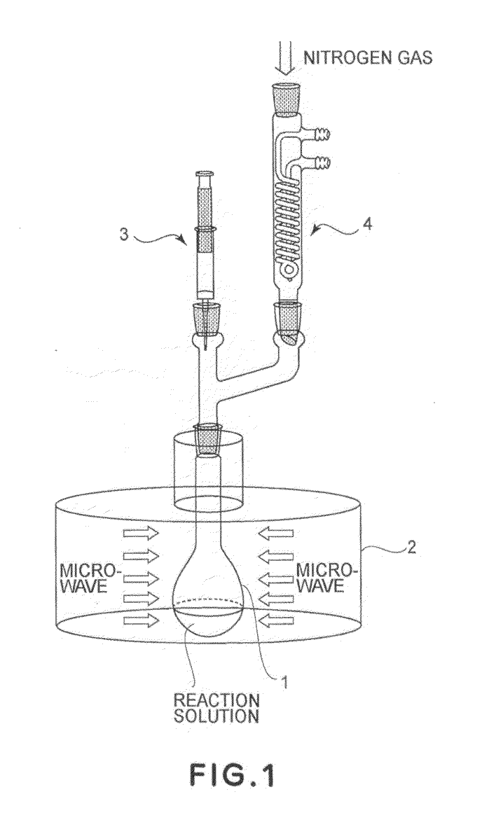

FIG. 1 is a schematic view showing an experimental system in this embodiment.

With reference to FIG. 1, this embodiment will be described.

After 10 g (26 mmol) of trioctylphosphine oxide (TOPO; melting point=52° C.) was placed in a three-necked quartz flask 1 and melted at 55° C. in a nitrogen atmosphere, 0.9 ml (8 mmol) of titanium tetrachloride (TiCl₄) was added. When the reaction system was irradiated with a microwave by a microwave reaction apparatus (“Discover”, mfd. by CEM Corp.; 2.45 GHz single mode; microwave maximum output=150 W; maximum density=15 W/cm³) at an irradiation density of 15 W/cm³, the temperature of the reaction system was increased up to 290° C. in 5 minutes or less. Thereafter, into the reaction system, 2.4 ml (8 mmol) of titanium tetraisopropoxide (Ti(OiPr)₄) was quickly added through a syringe 3, followed by stirring for 10 minutes under heating. The microwave irradiation was continued also during the stirring so as to keep the reaction temperature at 290° C. A reference numeral 4 represents a condenser tube (pipe).

After the stirring under heating, the reaction system was cooled at room temperature by compressed air. To the reaction system, 50 ml of ethanol was added, followed by centrifugal separation by a centrifuge (“CR22G”, mfd. by Hitachi, Ltd.; 40,000G (18,000 rpm); 10 minutes) to obtain a sediment. The sediment was air-dried at room temperature to obtain pale yellow powder.

### COMPARATIVE EXAMPLE

Synthesis of titanium oxide fine particles was performed in accordance with a procedure described in the nonpatent document 1. In an argon atmosphere, 26.25 g of heptadecane, 9.75 g of TOPO, and 0.33 ml (3 mmol) of TiCl₄ were placed in a 100 ml-three-necked flask and heated up to 300° C. in a heating mantle. Due to heating by heat conduction, it took one hour or more to increase the temperature of the reaction system up to 300° C. To the reaction system, 0.9 ml (3 mmol) of Ti(OiPr)₄ was quickly added through a syringe, followed by heating for 5 minutes. The heating in the heating mantle was continued also during the stirring. After the stirring under heating, the reaction system was coated to room temperature. Under stirring, the reaction system (solution) was added dropwise into 300 ml of acetone. By centrifugal separation (3,000 rpm; 10 minutes), a supernatant liquid was removed and thereafter 150 ml of hexane was added, followed by re-dispersion. The re-dispersed hexane solution was added gradually to 400 ml of acetone to effect re-precipitation. This operation was repeated three times in total. The precipitate was air-dried at room temperature to obtain pale yellow powder.

### Analysis

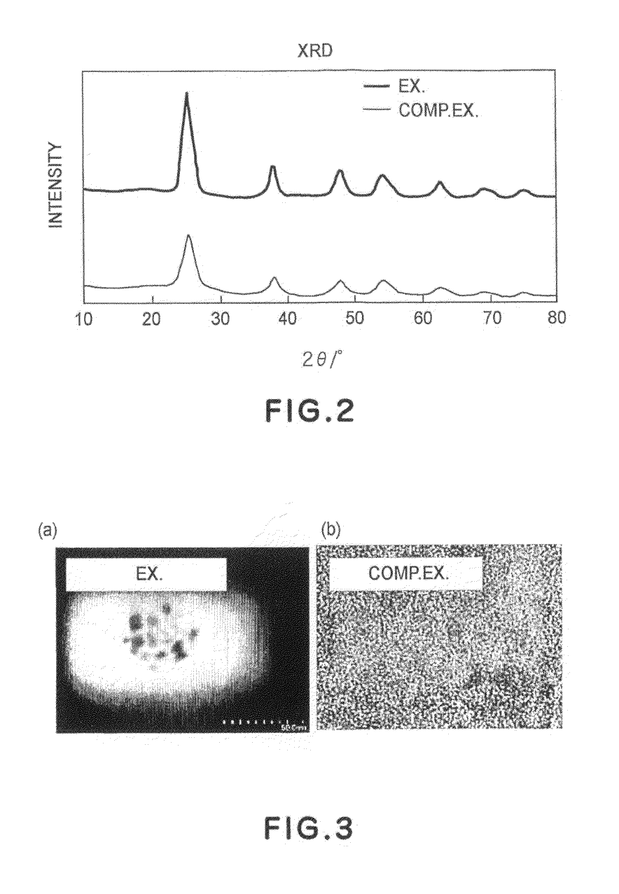

The above-obtained two powders in Example and Comparative Example was subjected to X-ray diffraction (XRD) measurement, observation through a transmission electron microscope (TEM), analysis by an infrared absorption spectrum analyzer (FTIR-ATR), thermogravimetric analysis (TGA), and a dispersion test in an organic solvent. A spectrum, of each of the titanium oxide fine particles in Example and Comparative Example, obtained by the XRD measurement was shown in FIG. 2. From the spectrum, it was found that either of the two powders (titanium oxide fine particles) was anatase-phase titanium dioxide fine particles (PDF #21-1272). A crystallite size calculated from a peak at 2θ=about 25 deg. was found to be 5.8 nm for the powder obtained in Example and 4.2 nm for the powder obtained in Comparative Example. Here, the crystalline size is a value D(101) calculated, from X-ray diffraction peak in (101) plane, by using the following Debye-Scherrer formula:

D(101)=K×λ/βcosθ,

wherein D(101) represents the crystallite size, K=0.9, λCu-Kα1=0.154056 nm, and β represents a diffraction peak width at half height.

From an image of a transmission electron microscope (TEM) (“S4800”, mfd. by Hitachi, Ltd.), a particle size of the titanium oxide fine particles obtained in Example was 5-10 nm (Example 3(A)). For the TEM observation, a carbon-coated copper grid (“STEM 100Cu”, mfd. by Okenshoji, Co., Ltd.) was used. The crystallite size of 5-10 nm obtained from the TEM image well coincided with the crystallite size of 5.8 nm calculated through the XRD measurement. Further, it was observed that adjacent particles were distant from each other by about 2 nm. A molecular length of TOPO calculated by semiempirical molecular orbit method (PM3) (“Spartan”, available from Wavefunction, Inc.) is 0.9 nm, so that the TOPO is present and bonded to the particle surfaces. For this reason, it is considered that the fine particles are distant from each other by about 2 nm.

On the other hand, a fringe of the titanium oxide fine particles obtained in Comparative Example was observed through a TEM (“HF2000”, mfd. by Hitachi, Ltd.) (FIG. 3(b)). A fringe spacing was 0.357 nm, which substantially coincided with (101) interplanar spacing d=0.352000 nm of the anatase-phase titanium oxide fine particles.

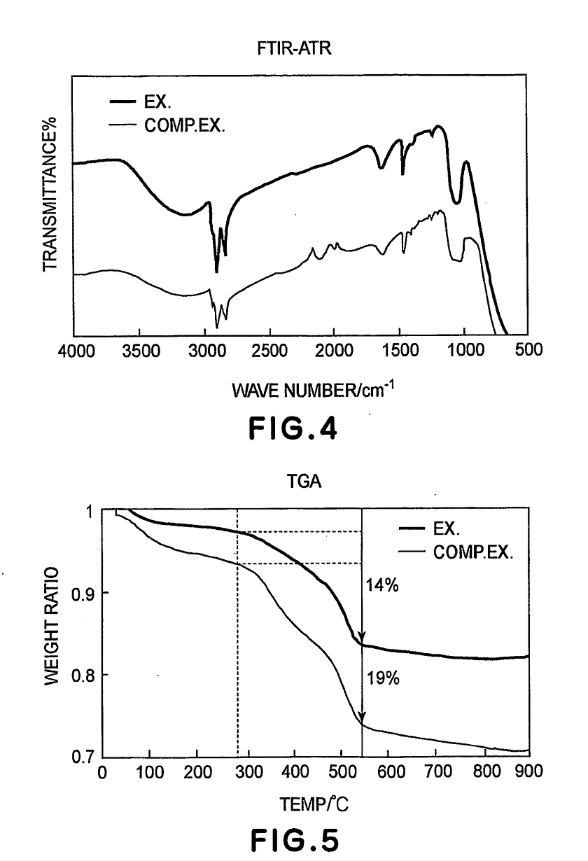

In order to more specifically observe a bonding state between the particle surface and the TOPO with respect to the titanium oxide fine particles obtained in Example and Comparative Example, FTIR-ATR measurement (“Spectrum One”, mfd. by Perkin Elmer, Inc.; measuring range=4000-650 cm⁻¹) was performed. At a wave number of about 1065 cm⁻¹, a relatively strong peak was observed with respect to the titanium oxide fine particles of Example (FIG. 4). This peak may be attributable to coordinate bond between Ti⁴⁺ and P=O group of the TOPO. On the other hand, with respect to the titanium oxide fine particles of Comparative Example, it is found that a corresponding peak is weaker than that for the titanium oxide fine particles of Example. It is considered that this means that the number of formed coordinate bond with respect to the titanium oxide fine particles of Comparative Example is less than that with respect to the titanium oxide fine particles of Example. When analysis through TGA (“Thermo Plus”, mfd.

by Rigaku Corp.) was performed at 10° C./min., in a temperature area of 280-550° C., a weight loss of 14% was observed for a sample of Example (FIG. 5). It is known that the weight loss is caused to occur in this temperature area by decomposition of an organic material, so that a proportion of the surface modifier TOPO present at the TiO₂ fine particles surface to the entire weight of the TOPO is estimated as 14%. On the other hand, in the temperature area of 280-550° C., a weight loss of 19% was observed for a sample of Comparative Example (FIG. 5). That is, a proportion of the surface modifier TOPO present at the TiO₂ fine particles surfaces to the entire weight of the TOPO was 19%, so that it was found that the TOPO present at the particle surfaces is larger in amount than that in the case of Example. In Comparative Example, the amount of the coordinate bond is smaller but the weight proportion is larger compared with those in Example. For this reason, it is considered that a large amount of organic molecules which are not coordinate-bonded to the particle surfaces but are simply deposited on the particle surfaces.

A test whether or not each of the powders of Example and Comparative Example was dispersed in an organic solvent (chloroform) was performed.

When the titanium oxide fine particles obtained in Example were added and dispersed into chloroform, a dispersion was transparent to visible light and such a phenomenon that a part of the fine particles is settled was not caused to occur. Thus, it is found that the titanium oxide fine particles were well dispersed in the organic solvent in a primary particle state without causing agglomeration.

On the other hand, when the titanium oxide fine particles obtained in Comparative Example were added and dispersed into chloroform, a dispersion was suspended and shortly after the addition, a part of powder was settled. That is, dispersibility of the titanium oxide fine particles into the organic solvent was not sufficient.

As described above, the metal oxide fine particles of the present invention exhibit a nonconventional dispersibility with respect to the organic solvent. It is difficult to more specifically analyze the surface state of nanoparticles at present when accuracy and the like of analytical equipment are taken into consideration but it is considered that some change in surface state is caused by the metal oxide fine particles according to the present invention when compared with the conventional metal oxide fine particles.

### INDUSTRIAL APPLICABILITY

According to the present invention, it is possible to provide metal oxide fine particles exhibiting nonconventional dispersibility into an organic solvent as primary particles although they are nanoscale fine particles liable to cause agglomeration. Further, according to the production process of the metal oxide fine particles of the present invention, it is possible to obtain metal oxide fine particles exhibiting high dispersibility into the organic solvent in a short time.

While the invention has been described with reference to the structures disclosed herein, it is not confined to the details set forth and this application is intended to cover such modifications or changes as may come within the purpose of the improvements or the scope of the following claims.

1. Metal oxide fine particles obtained by heating metal halide and metal alkoxide in the presence of phosphine oxide,
wherein the heating is performed by microwave irradiation.

2. Particles according to claim 1, wherein the phosphine oxide is trialkylphosphine oxide containing an alkyl group having 4-20 carbon atoms.

3. Titanium oxide fine particles obtained by heating and reacting titanium halide and titanium alkoxide in the presence of phosphine oxide,
wherein the heating is performed by microwave irradiation.

4. Particles according to claim 1 or 2, wherein said metal oxide fine particles have a particle size of 1 nm or more and 100 nm or less.

5. Particles according to claim 3, wherein said titanium oxide fine particles have a particle size of 1 nm or more and 100 nm or less.

6. A process for producing metal oxide fine particles, comprising:
heating metal halide and metal alkoxide in the presence of phosphine oxide through microwave irradiation.

7. A process according to claim 6, wherein the phosphine oxide is trialkylphosphine oxide containing an alkyl group having 4-20 carbon atoms.

8. A process for producing titanium oxide fine particles, comprising:
heating and reacting titanium halide and titanium alkoxide in the presence of phosphine oxide, wherein the heating is performed by microwave irradiation.

9. A process according to claim 6 or 7, wherein the metal oxide fine particles have a particle size of 1 nm or more and 100 nm or less.

10. A process according to claim 8, wherein the titanium oxide fine particles have a particle size of 1 nm or more and 100 nm or less.
